(19) United States
(12) Patent Application Publication
(10) Pub. No.: US 2025/0159529 A1
(43) Pub. Date: May 15, 2025

(54) COMMUNICATION METHOD AND APPARATUS, ELECTRONIC DEVICE, AND STORAGE MEDIUM

(71) Applicant: Beijing Xiaomi Mobile Software Co., Ltd., Beijing (CN)

(72) Inventor: Xiandong DONG, Beijing (CN)

(73) Assignee: Beijing Xiaomi Mobile Software Co., Ltd., Beijing (CN)

(21) Appl. No.: 18/838,696

(22) PCT Filed: Feb. 16, 2022
(86) PCT No.: PCT/CN2022/076528

§ 371 Date: Aug. 15, 2024

(51) Int. Cl. H04W 24/10; H04L 5/00; H04W 84/12

(52) U.S. Cl. CPC H04W 24/10; H04L 5/0044; H04W 84/12

(57) ABSTRACT

A communication method includes: determining a wireless frame, wherein the wireless frame comprises first indication, and the first indication indicates a wireless local area network (WLAN) sensing measurement process corresponding to the wireless frame; and sending the wireless frame to a sensing responder to instruct the sensing responder to receive a null data packet (NDP).

### CROSS-REFERENCE TO RELATED APPLICATIONS

The present application is a U.S. National Stage of International Application No. PCT/CN2022/076528, filed on Feb. 16, 2022, the disclosure of which is incorporated herein by reference in its entirety for all purposes.

### TECHNICAL FIELD

The embodiments of the present disclosure relate to the field of mobile communication technology, and specifically, the embodiments of the present disclosure relate to a communication method and apparatus, an electronic device, and a storage medium.

### BACKGROUND

With rapid development of mobile communication technology, Wireless Fidelity (Wi-Fi) technology has made great progress in transmission rate, throughput, etc. At present, what is studied in Wi-Fi technology includes, for example, 320 MHz bandwidth transmission, aggregation and coordination of multiple frequency bands, etc. Its main application scenarios include video transmission, augmented reality (AR), virtual reality (VR), etc.

In the Wi-Fi technologies currently being studied, wireless local area network (WLAN) sensing technology may be supported, for example, in the application scenarios such as location discovery, proximity detection, and presence detection in dense environments (such as home and corporate environments). In the WLAN sensing process, Null Data Packet Announcement (NDPA) is used for measurement of sensing.

### SUMMARY

The embodiments of the present disclosure provide a communication method and apparatus, an electronic device, and a storage medium.

In an aspect, the embodiments of the present disclosure provide a communication method, which is applied to a sensing initiator, and the method includes:
determining a wireless frame, wherein the wireless frame includes first indication, and the first indication indicates a wireless local area network (WLAN) sensing measurement process corresponding to the wireless frame; and
sending the wireless frame to a sensing responder to indicate the sensing responder to receive a null data packet (NDP).

In an aspect, the embodiments of the present disclosure provide a communication method, which is applied to a sensing responder, and the method includes:
receiving a wireless frame, and obtain first indication carried in the wireless frame, wherein the first indication indicates a wireless local area network (WLAN) sensing measurement process corresponding to the wireless frame; and
receiving a null data packet (NDP) according to the first indication.

In another aspect, the embodiments of the present disclosure further provide a network device, the network device being a sensing initiator, and the network device includes:
a determination module, configured to determine a wireless frame, wherein the wireless frame includes first indication, and the first indication indicates a wireless local area network (WLAN) sensing measurement process corresponding to the wireless frame; and
a sending module, configured to send the wireless frame to a sensing responder to indicate the sensing responder to receive a null data packet (NDP).

In another aspect, the embodiments of the present disclosure further provide a network device, the network device being a sensing responder, and the network device includes:
a first receiving module, configured to receive a wireless frame, and obtain first indication carried in the wireless frame, wherein the first indication indicates a wireless local area network (WLAN) sensing measurement process corresponding to the wireless frame; and
a second receiving module, configured to receive a null data packet (NDP) according to the first indication.

In another aspect, the embodiments of the present disclosure further provide a communication apparatus, applied to a sensing initiator, and the apparatus includes:
a wireless frame determination module, configured to determine a wireless frame, wherein the wireless frame includes first indication, and the first indication indicates a wireless local area network (WLAN) sensing measurement process corresponding to the wireless frame; and
a wireless frame sending module, configured to send the wireless frame to a sensing responder to indicate the sensing responder to receive a null data packet (NDP).

In another aspect, the embodiments of the present disclosure further provide a communication apparatus, applied to a sensing responder, and the apparatus includes:
a third receiving module, configured to receive a wireless frame, and obtain first indication carried in the wireless frame, wherein the first indication indicates a wireless local area network (WLAN) sensing measurement process corresponding to the wireless frame; and
a fourth receiving module, configured to receive a null data packet (NDP) according to the first indication.

The embodiments of the present disclosure also provide an electronic device, including a memory, a processor, and a computer program that is stored in the memory and is executable on the processor, wherein when executing the program, the processor implements one or more of the method described in the embodiments of the present disclosure.

The embodiments of the present disclosure further provide a computer-readable storage medium having stored thereon a computer program which, when being executed by a processor, implements one or more of the methods described in the embodiments of the present disclosure.

Additional aspects and advantages of the embodiments of the present disclosure will be partially provided in the description below, which will become apparent from the description below, or will be learned through the practice of the present disclosure.

### BRIEF DESCRIPTION OF THE DRAWINGS

In order to more clearly illustrate the technical solutions of the embodiments of the present disclosure, the drawings that are to be used in the description of the embodiments of the present disclosure will be briefly introduced below. Obviously, the drawings in the following description are only some embodiments of the present disclosure, and those of ordinary skill in the art can obtain other drawings based on these drawings without paying creative effort.

FIG. 1 is a first flowchart of a communication method provided in an embodiment of the present disclosure;

FIG. 2 is a first schematic diagram of a first example according to an embodiment of the present disclosure;

FIG. 3 is a second schematic diagram of the first example according to an embodiment of the present disclosure;

FIG. 4 is a third schematic diagram of the first example according to an embodiment of the present disclosure;

FIG. 5 is a second flowchart of a communication method provided by an embodiment of the present disclosure;

FIG. 6 is a first schematic diagram of a structure of a network device provided in an embodiment of the present disclosure;

FIG. 7 is a second schematic diagram of a structure of a network device provided in an embodiment of the present disclosure; and

FIG. 8 is a schematic diagram of a structure of an electronic device provided in an embodiment of the present disclosure.

### DETAILED DESCRIPTION

In the embodiments of the present disclosure, the term “and/or” describes association relationship of associated objects, indicating that there can be three types of relationships. For example, A and/or B may indicate three cases where A exists alone, A and B exist at the same time, and B exists alone. The character “/” generally indicates that the related objects before and after this character are in an “or” relationship.

The term “a plurality of” in the embodiments of the present disclosure refers to two or more than two, and other quantifiers are similar thereto.

The illustrative embodiments will be described in detail herein, examples of which are shown in the accompanying drawings. When the drawings are involved in the following description, the same numbers in different drawings represent the same or similar elements, unless otherwise indicated. The embodiments described in the following illustrative embodiments do not represent all embodiments consistent with the present disclosure. Instead, they are merely examples of devices and methods consistent with some of aspects of the present disclosure as detailed in the appended claims.

The terms used in the present disclosure are for the purpose of describing specific embodiments only and are not intended to restrict the present disclosure. The singular forms of “a”, “said” and “the” used in the present disclosure and the appended claims are also intended to include plural forms unless the context clearly indicates otherwise. It should also be understood that the term “and/or” used herein refers to and includes any or all possible combinations of one or more associated items listed.

It should be understood that although the terms of first, second, third, etc. may be used in the present disclosure to describe various information, such information should not be limited to these terms. These terms are only used to distinguish the same type of information from each other. For example, without departing from the scope of the present disclosure, the first information may also be referred to as the second information, and similarly, the second information may also be referred to as the first information. Depending on the context, for example, the wording “if” used herein may be interpreted as “at the time of . . . ” or “when . . . ” or “in response to determining”.

A clear and complete description of technical solutions in the embodiments of the present disclosure will be provided below in combination with the drawings in the embodiments of the present disclosure. Obviously, the described embodiments are only a part of the embodiments of the present disclosure, but not all of the embodiments. Based on the embodiments in the present disclosure, all other embodiments obtained by those of ordinary skill in the art without paying creative effort fall within the protection scope of the present disclosure.

The embodiments of the present disclosure provide a communication method and apparatus, an electronic device, and a storage medium, which are used to provide a format of an NDPA frame in a WLAN Sensing process.

The method and the device are based on the same inventive concept. Since the principles for the method and the device to solve the problem are similar, the implementations of the device and the method can be referenced with each other, and the repeated parts will not be omitted.

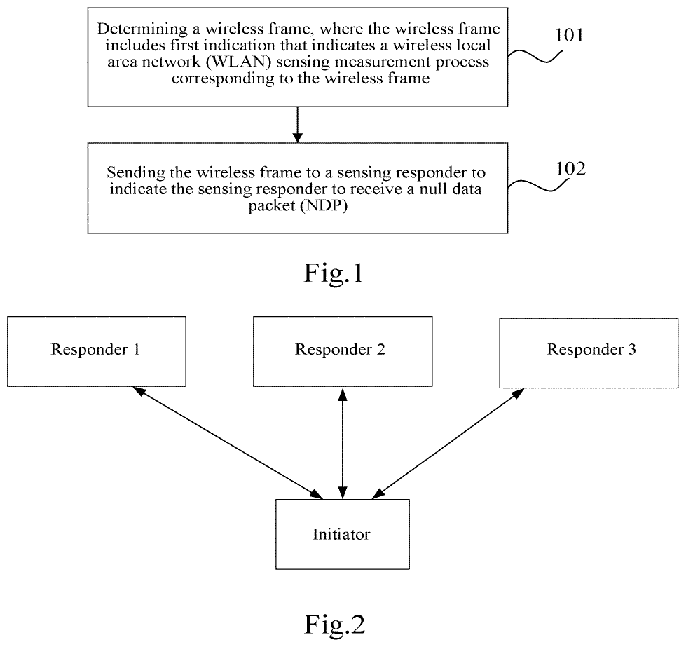

As shown in FIG. 1, an embodiment of the present disclosure provides a communication method. In some embodiments, the method may be applied to a network device, and the network device may be a sensing initiator. The method may include the following steps.

In step 101, a wireless frame is determined, where the wireless frame includes first indication, and the first indication indicates a wireless local area network (WLAN) sensing measurement process corresponding to the wireless frame.

As a first example, referring to FIG. 2 to FIG. 4, a WLAN Sensing architecture and a WLAN Sensing process for the WLAN sensing measurement method provided in the embodiments of the present disclosure are introduced first.

FIG. 2 is a schematic diagram showing the architecture for WLAN Sensing (process), in which a sensing initiator (or an initiator) initiates WLAN Sensing (for example, initiates a WLAN sensing session), and there may be multiple sensing responders (or sensing receivers) or responders that respond to it, such as responder 1, responder 2, and responder 3 as shown in FIG. 2. When the sensing initiator initiates WLAN Sensing, multiple associated or unassociated sensing responders for the WLAN Sensing may respond to it.

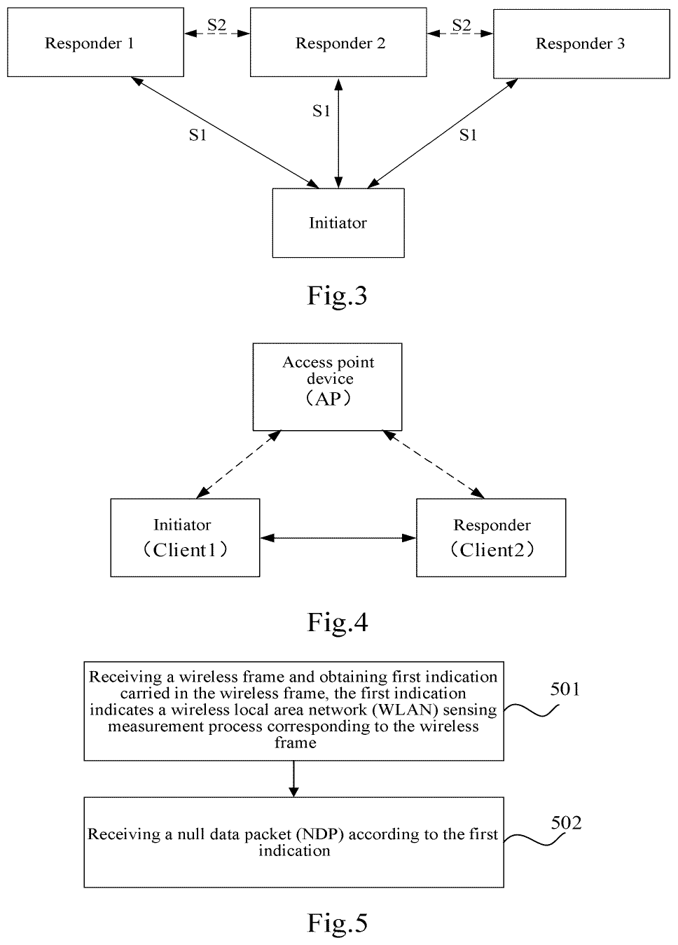

Referring to FIG. 3, the sensing initiator communicates with the sensing responder via communication connection, such as communication connection S1 as shown, and the sensing responders communicate with each other via communication connection S2.

Each of the sensing initiators can be a client, and each of the sensing responders (in this example, sensing responders 1 to 3) can be a station device (STA) or an access point device (AP). In addition, STA and AP can serve multiple roles in the WLAN sensing process. For example, in the WLAN sensing process, STA can also serve as a sensing initiator, and the sensing initiator can be a sensing transmitter, a sensing receiver, or both, or neither. In the WLAN sensing process, the sensing responder can also be a sensing transmitter, a sensing receiver, or both.

As another architecture, as shown in FIG. 4, the sensing initiator and the sensing responder can both be clients, and they can perform communication by connecting to the same access point device (AP). In FIG. 4, Client 1 is the sensing initiator, and Client 2 is the sensing responder.

Generally, in the WLAN sensing process, for example, in a downlink sensing measurement (DL Sensing) process, the initiator determines a wireless frame and carries first indication in the wireless frame, where the first indication indicates a wireless local area network (WLAN) sensing measurement process corresponding to the wireless frame. In some embodiments, the first indication may include a sensing measurement setup identifier (Measurement Setup ID) and/or a sensing measurement instance identifier (Measurement Instance ID), and each Measurement Setup ID may correspond to one or more Measurement Instance IDs. The first indication is carried in the wireless frame to indicate to the sensing responder the WLAN sensing measurement process corresponding to the wireless frame. For example, the Measurement Setup ID and/or the Measurement Instance ID may be carried in a sounding dialog token field of the wireless frame.

Step 102: The wireless frame is sent to a sensing responder to indicate the sensing responder to receive a null data packet (NDP).

In some embodiments, in the DL Sensing Sounding process of the WLAN Sensing scenarios, the type of the wireless frame may be a WLAN Sensing NDPA frame. The NDPA (Null Data Packet Announcement) frame is used to indicate the responder to receive a null data packet (NDP). For example, in the DL Sensing Sounding process, after sending the NDPA frame, the sensing initiator sends an NDP, and thus the sensing responder needs to receive the NDP frame. It can be understood that in the WLAN Sensing process, there may be multiple sensing responders participating in the Measurement Instance.

In the embodiments of the present disclosure, a wireless frame is determined, the wireless frame includes first indication, and the first indication indicates a wireless local area network (WLAN) sensing measurement process corresponding to the wireless frame; the wireless frame is sent to a sensing responder, indicating the sensing responder to receive a null data packet. The embodiments of the present disclosure provide a format of an NDPA frame to implement the WLAN sensing measurement.

In some embodiments, the first indication includes: a sensing measurement setup identifier (Measurement Setup ID) included in the WLAN sensing measurement process, and/or a sensing measurement instance identifier (Measurement Instance ID) corresponding to the sensing measurement setup identifier. The sensing measurement setup identifier is used to identify the sensing measurement process. The WLAN sensing measurement process may include one or more sensing measurement instances, that is, each Measurement Setup ID may correspond to one or more Measurement Instance IDs. The first indication may carry the Measurement Setup ID, may directly carry the Measurement Instance ID (the Measurement Instance ID can uniquely identify a sensing measurement instance), or may also include the both.

In some embodiments, the wireless frame includes a sounding dialog token field.

The first indication is carried in the sounding dialog token field, and in some embodiments, the aforementioned Measurement Setup ID and the corresponding Measurement Instance ID can be carried in a sounding dialog token sub-field. The sounding dialog token field can be composed of two parts: Measurement Setup ID and Measurement Instance ID, where the same Measurement Setup ID may contain multiple Measurement Instance IDs.

In some embodiments, the wireless frame includes a station information (STA info) field, and the NDPA frame includes at least one STA info field.

The STA info field includes an association identifier (AID) identification field or a user identifier (USID) identification field, and the AID identification field or USID identification field indicates the responder participating in the WLAN sensing measurement process, that is, the AID identification field or USID identification field indicates the responder of the sensing sounding, where AID stands for Association Identifier, and USID stands for User Identifier. In some embodiments, AID of a responder that has not established association (i.e., communication connection) with the initiator can be allocated to the responder by the initiator during a WLAN sensing measurement setup process.

In some embodiments, the STA info field also includes sensing measurement parameter information corresponding to the AID identification field or the USID identification field, and the sensing measurement parameter information may include partial bandwidth domain (partial BW) information, Resource Unit (RU) information and/or Number Of Spatial Stream (NSS) parameter information. The RU information is determined based on the transmission bandwidth of the NDPA frame. For example, when the transmission bandwidth is 20 MHz, it indicates that RU information is feedback based on 26-tone (communication protocol 802.11ax version), or feedback based on 242-tone (communication protocol 802.11be version). If there is a mixture of 802.11ax and 802.11be, it is 26-tone feedback. In some embodiments, the NSS number identifies the NSS parameter information for transmission of the downlink measurement NDP frame.

In some embodiments, the STA info field further includes parameter information corresponding to transmission of the NDP by the responder. In the WLAN Sensing process, after receiving the NDPA frame, the responder also feedbacks an NDP frame (which is a different NPD from the NDP received by the sensing responder indicated in step 102) to the sensing initiator. Therefore, the STA info field also includes parameter information of the NDP frame sent by the responder, such as NSS information, bandwidth information, etc.

In some embodiments, the wireless frame further includes second indication, which indicates that the type of the wireless frame is a wireless local area network sensing null data packet announcement (WLAN Sensing NDPA) frame. In the DL Sensing Sounding process of the WLAN Sensing scenarios, the Null Data Packet Announcement (NDPA) frame is used to indicate the responder to receive a Null Data Packet (NDP).

In some embodiments, the second indication is carried in a control field of the wireless frame, a subtype subfield of the control field, or a sounding dialog token field.

As an example, taking the control field as an example, in conjunction with the following Table 1, combinations of the valid type field and subtype subfield of the wireless frame are as shown in Table 1:

TABLE 1

| Type value | Type | Subtype value | Subtype |
|---|---|---|---|
| B3 B2 | description | B7 B6 B5 B4 | description |
| . . . | | | |
| 01 | Control | 0000-0001 | Reserved |
| 01 | | 0010 | Trigger |
| . . . | | | |
| 01 | Control | 0101 | VHT/HENDP |
| | | | Announcement |

. . .

When the Type value is 01, it is the control field, and the second indication can be carried in the control field. For example, the second indication can be carried in the subtype subfield corresponding to bits 0000-0001.

In addition, a bit in the sounding dialog token field may be used to identify the second indication.

In the embodiments of the present disclosure, the sensing initiator determines the wireless frame, where the wireless frame includes the first indication, and the first indication indicates the wireless local area network (WLAN) sensing measurement process corresponding to the wireless frame; the wireless frame is sent to the sensing responder, indicating the sensing responder to receive the null data packet. The embodiments of the present disclosure provide a format of the NDPA frame to implement WLAN sensing measurement.

The embodiments of the present disclosure also provide a communication method, which can be applied to a network device, and the network device can be a sensing initiator. The method may include the following steps of:
determining a wireless frame; wherein the wireless frame includes first indication, and the first indication includes: a sensing measurement setup identifier included in a WLAN sensing measurement process, and/or a sensing measurement instance identifier corresponding to the sensing measurement setup identifier; and
sending the wireless frame to a sensing responder to indicate the sensing responder to receive a null data packet (NDP).

The embodiments of the present disclosure also provide a communication method, which can be applied to a network device, and the network device can be a sensing initiator. The method can include the following steps of:
determining a wireless frame, where the wireless frame includes a station information (STA info) field, the STA info field includes an association identifier (AID) identification field or a user identifier (USID) identification field, where the AID identification field or the USID identification field indicates a responder participating in the WLAN sensing measurement process; and
sending the wireless frame to a sensing responder to indicate the sensing responder to receive a null data packet (NDP).

In some embodiments, the STA info field also includes sensing measurement parameter information corresponding to the AID identification field or the USID identification field.

In some embodiments, the STA info field also includes parameter information corresponding to transmission of a NDP by the responder.

The embodiments of the present disclosure also provide a communication method, which can be applied to a network device, and the network device can be a sensing initiator. The method can include the following steps of:
determining a wireless frame, where the wireless frame further includes second indication, the second indication indicates that a type of the wireless frame is a wireless local area network sensing null data packet announcement (WLAN Sensing NDPA) frame; and
sending the wireless frame to a sensing responder to indicate the sensing responder to receive a null data packet (NDP).

In some embodiments, the second indication is carried in a control field of the wireless frame, a subtype subfield of the control field, or a sounding dialog token field.

Referring to FIG. 5, the embodiments of the present disclosure further provide a communication method, which is applied to a sensing responder, and the method includes the following.

In step 501, a wireless frame is received and first indication carried in the wireless frame is obtained, where the first indication indicates a wireless local area network (WLAN) sensing measurement process corresponding to the wireless frame.

As a first example, referring to FIG. 2 to FIG. 4, an architecture of WLAN Sensing and a WLAN Sensing process applied in the communication method provided in the embodiments of the present disclosure are first introduced. For details, reference can be made to the above embodiments, which will not be repeated here.

In a WLAN sensing process, for example, in a downlink sensing measurement (DL Sensing) process, the initiator determines a wireless frame and carries first indication in the wireless frame, where the first indication indicates a wireless local area network (WLAN) sensing measurement process corresponding to the wireless frame. In some embodiments, the first indication may include a measurement sensing measurement setup identifier (Measurement Setup ID) and/or a sensing measurement instance identifier (Measurement Instance ID), each Measurement Setup ID may correspond to one or more Measurement Instance IDs, and the first indication is carried in the wireless frame to indicate to the sensing responder the WLAN sensing measurement process corresponding to the wireless frame. For example, the Measurement Setup ID and/or the Measurement Instance ID may be carried in a sounding dialog token field of the wireless frame.

In step 502, a null data packet (NDP) is received according to the first indication.

In some embodiments, in the DL Sensing Sounding process of the WLAN Sensing scenarios, the type of the wireless frame may be a WLAN Sensing NDPA frame. The NDPA (Null Data Packet Announcement) frame is used to indicate the responder to receive a Null Data Packet (NDP). For example, in the DL Sensing Sounding process, after sending the NDPA frame, the sensing initiator sends an NDP, and thus the sensing responder needs to receive the NDP frame. It can be understood that in the WLAN Sensing process, there may be multiple sensing responders participating in the Measurement Instance.

In the embodiments of the present disclosure, the sensing responder receives the wireless frame, obtains the first indication carried in the wireless frame, the first indication indicating the wireless local area network (WLAN) sensing measurement process corresponding to the wireless frame; and receives the null data packet (NDP) based on the first indication. The embodiments of the present disclosure provide a format of the NDPA frame to implement the WLAN sensing measurement.

In some embodiments, the first indication includes: a sensing measurement setup identifier (Measurement Setup ID) included in the WLAN sensing measurement process, and/or a sensing measurement instance identifier (Measurement Instance ID) corresponding to the sensing measurement setup identifier. The sensing measurement setup identifier is used to identify the sensing measurement process, and the WLAN sensing measurement process may include one or more sensing measurement instances, that is, each Measurement Setup ID may correspond to one or more Measurement Instance IDs. The first indication may carry the Measurement Setup ID, may directly carry the Measurement Instance ID (the Measurement Instance ID can uniquely identify a sensing measurement instance), or may also include both at the same time.

In some embodiments, the wireless frame includes a sounding dialog token field.

The first indication is carried in the sounding dialog token field. In some embodiments, the above Measurement Setup ID and the corresponding Measurement Instance ID can be carried in the sounding dialog token subfield. The sounding dialog token field can be composed of two parts: Measurement Setup ID and Measurement Instance ID, and the same Measurement Setup ID may contain multiple Measurement Instance IDs.

In some embodiments, the wireless frame includes a station information (STA info) field, and the NDPA frame includes at least one STA info field.

The STA info field includes an association identifier (AID) identification field or a user identifier (USID) identification field, and the AID identification field or USID identification field indicates the responder participating in the WLAN sensing measurement process, that is, the AID identification field or USID identification field indicates the responder of the sensing sounding. The AID stands for Association Identifier, and USID stands for User Identifier. In some embodiments, AID of a responder that has not established association (i.e., communication connection) with the initiator can be allocated to the responder by the initiator during the WLAN sensing measurement setup process.

In some embodiments, the STA info field also includes sensing measurement parameter information corresponding to the AID identification field or the USID identification field, and the sensing measurement parameter information may include partial bandwidth domain (partial BW) information, Resource Unit (RU) information and/or Number Of Spatial Stream (NSS) parameter information. The RU information is determined based on the transmission bandwidth of the NDPA frame. For example, when the transmission bandwidth is 20 MHz, it indicates that the RU information is feedback based on 26-tone (communication protocol 802.11ax version), or feedback based on 242-tone (communication protocol 802.11ax version). If there is a mixture of 802.11ax and 802.11ax, it is 26-tone feedback. In some embodiments, the NSS number identifies the NSS parameter information of the downlink measurement NDP frame.

In some embodiments, the STA info field further includes parameter information corresponding to transmission of a NDP by the responder. In the WLAN Sensing process, after receiving the NDPA frame, the responder will feedback a NDP frame to the sensing initiator. Therefore, the STA info field also includes parameter information for the responder to send the NDP frame, such as NSS information, bandwidth information, etc.

In some embodiments, the wireless frame also includes second indication, which indicates that the type of the wireless frame is a wireless local area network sensing null data packet announcement (WLAN Sensing NDPA) frame. In the DL Sensing Sounding process of the WLAN Sensing scenarios, the Null Data Packet Announcement (NDPA) frame is used to indicate the responder to receives the null data packet (NDP).

In some embodiments, the second indication is carried in a control field of the wireless frame, a subtype subfield of the control field, or a sounding dialog token field.

As an example, taking the control field as an example, in conjunction with the following Table 1, combinations of the valid type field and subtype subfield of the wireless frame are as shown in Table 1:

TABLE 1

| Type value | Type | Subtype value | Subtype |
|---|---|---|---|
| B3 B2 | description | B7 B6 B5 B4 | description |
| . . . | | | |
| 01 | Control | 0000-0001 | Reserved |
| 01 | | 0010 | Trigger |
| . . . | | | |
| 01 | Control | 0101 | VHT/HE NDP |
| | | | Announcement |

. . .

When the Type value is 01, it is the control field, and the second indication can be carried in the control field. For example, the second indication can be carried in the subtype subfield corresponding to bits 0000-0001.

In addition, a bit in the sounding dialog token field may be used to identify the second indication.

In an embodiment of the present disclosure, the sensing responder receives the wireless frame, obtains the first indication carried in the wireless frame, the first indication indicating the wireless local area network (WLAN) sensing measurement process corresponding to the wireless frame; and receives the null data packet (NDP) based on the first indication. The embodiment of the present disclosure provides a format of the NDPA frame to implement the WLAN sensing measurement.

The embodiments of the present disclosure also provide a communication method, which can be applied to a network device, and the network device can be a sensing responder. The method may include the following steps of:
receiving a wireless frame; where the wireless frame includes first indication, and the first indication includes a sensing measurement setup identifier included in a WLAN sensing measurement process, and/or a sensing measurement instance identifier corresponding to the sensing measurement setup identifier; and
receiving a null data packet (NDP) according to the first indication.

The embodiments of the present disclosure also provide a communication method, which can be applied to a network device, and the network device can be a sensing responder. The method may include the following steps of:
receiving a wireless frame, where the wireless frame includes a station information (STA info) field, the STA info field includes an association identifier (AID) identification field or a user identifier (USID) identification field, where the AID identification field or the USID identification field indicates the responder participating in the WLAN sensing measurement process; and
receiving a null data packet (NDP) according to the wireless frame.

In some embodiments, the STA info field also includes sensing measurement parameter information corresponding to the AID identification field or the USID identification field.

In some embodiments, the STA info field also includes parameter information corresponding to transmission of a NDP by the responder.

The embodiments of the present disclosure also provide a communication method, which can be applied to a network device, and the network device can be a sensing responder. The method may include the following steps of:
receiving a wireless frame, where the wireless frame further includes second indication, and the second indication indicates that the type of the wireless frame is a wireless local area network sensing null data packet announcement (WLAN Sensing NDPA) frame; and
receiving a null data packet (NDP) according to the wireless frame.

In some embodiments, the second indication is carried in a control field of the wireless frame, a subtype subfield of the control field, or a sounding dialog token field.

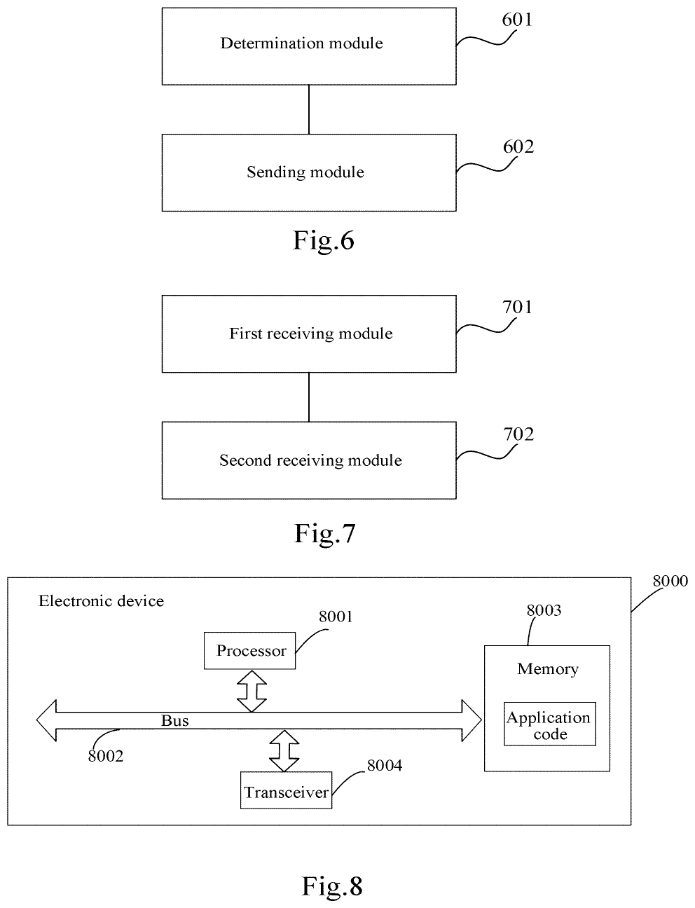

Based on the same principle as in the methods provided in the embodiments of the present disclosure, the embodiments of the present disclosure further provide a network device, the network device is a sensing initiator, and referring to FIG. 6, the network device includes:
a determination module 601, configured to determine a wireless frame, where the wireless frame includes first indication, and the first indication indicates a wireless local area network (WLAN) sensing measurement process corresponding to the wireless frame; and
a sending module 602, configured to send the wireless frame to a sensing responder to indicate the sensing responder to receive a null data packet (NDP).

In some embodiments, the first indication includes a sensing measurement setup identifier included in the WLAN sensing measurement process, and/or a sensing measurement instance identifier corresponding to the sensing measurement setup identifier.

In some embodiments, the wireless frame includes a sounding dialog token field.

The first indication is carried in the sounding dialog token field.

In some embodiments, the wireless frame includes a station information (STA info) field.

The STA info field includes an association identifier (AID) identification field or a user identifier (USID) identification field, and the AID identification field or the USID identification field indicates the responder participating in the WLAN sensing measurement process.

In some embodiments, the STA info field also includes sensing measurement parameter information corresponding to the AID identification field or the USID identification field.

In some embodiments, the STA info field also includes parameter information corresponding to transmission of a NDP by the responder.

In some embodiments, the wireless frame further includes second indication, and the second indication indicates that the type of the wireless frame is a wireless local area network sensing null data packet announcement (WLAN Sensing NDPA) frame.

In some embodiments, the second indication is carried in a control field of the wireless frame, a subtype subfield of the control field, or a sounding dialog token field.

In an embodiment of the present disclosure, the determination module 601 determines the wireless frame, the wireless frame includes the first indication, and the first indication indicates the wireless local area network (WLAN) sensing measurement process corresponding to the wireless frame; the sending module 602 sends the wireless frame to the sensing responder, indicating the sensing responder to receive the null data packet. The embodiment of the present disclosure provides a format of the NDPA frame to implement the WLAN sensing measurement.

The present disclosure also provides a communication apparatus, which is applied to a sensing initiator, and the apparatus includes:
a wireless frame determination module, configured to determine a wireless frame, where the wireless frame includes first indication, and the first indication indicates a wireless local area network (WLAN) sensing measurement process corresponding to the wireless frame; and
a wireless frame sending module, configured to send the wireless frame to a sensing responder to indicate the sensing responder to receive a null data packet (NDP).

The apparatus further includes other modules of the network device in the aforementioned embodiments, which will not be repeated here.

Referring to FIG. 7, an embodiment of the present disclosure further provides a network device, the network device is a sensing responder, and the network device includes:
a first receiving module 701, configured to receive a wireless frame and obtain first indication carried in the wireless frame, where the first indication indicates a wireless local area network (WLAN) sensing measurement process corresponding to the wireless frame; and
a second receiving module 702, configured to receive a null data packet (NDP) according to the first indication.

In some embodiments, the first indication includes a sensing measurement setup identifier included in the WLAN sensing measurement process, and/or a sensing measurement instance identifier corresponding to the sensing measurement setup identifier.

In some embodiments, the wireless frame includes a sounding dialog token field. The first indication is carried in the sounding dialog token field.

In some embodiments, the wireless frame includes a station information (STA info) field.

The STA info field includes an association identifier (AID) identification field or a user identifier (USID) identification field, and the AID identification field or the USID identification field indicates the responder participating in the WLAN sensing measurement process.

In some embodiments, the STA info field also includes sensing measurement parameter information corresponding to the AID identification field or the USID identification field.

In some embodiments, the STA info field also includes parameter information corresponding to transmission of a NDP by the responder.

In some embodiments, the wireless frame further includes second indication, and the second indication indicates that the type of the wireless frame is a wireless local area network sensing null data packet advertisement (WLAN Sensing NDPA) frame.

In some embodiments, the second indication is carried in a control field of the wireless frame, a subtype subfield of the control field, or a sounding dialog token field.

In an embodiment of the present disclosure, the first receiving module 701 receives the wireless frame and obtains the first indication carried in the wireless frame, the first indication indicates a wireless local area network (WLAN) sensing measurement process corresponding to the wireless frame; and the second receiving module 702 receives the null data packet (NDP) according to the first indication. The embodiment of the present disclosure provides a format of the NDPA frame to implement WLAN sensing measurement.

The present disclosure also provides a communication apparatus, which is applied to a sensing responder, and the apparatus includes:
a third receiving module, configured to receive a wireless frame, and obtain first indication carried in the wireless frame, where the first indication indicates a wireless local area network (WLAN) sensing measurement process corresponding to the wireless frame; and
a fourth receiving module, configured to receive a null data packet (NDP) according to the first indication.

The apparatus further includes other modules of the network device in the aforementioned embodiments, which will not be repeated here.

In some embodiments, the present disclosure further provides an electronic device, as shown in FIG. 8, the electronic device 8000 shown in FIG. 8 may be a server, including a processor 8001 and a memory 8003. The processor 8001 and the memory 8003 are connected with each other, such as through a bus 8002. In some embodiments, the electronic device 8000 may further include a transceiver 8004. It should be noted that in actual applications, the number of the transceiver 8004 is not limited to one, and the structure of the electronic device 8000 does not constitute a limitation on the embodiments of the present disclosure.

The processor 8001 may be a Central Processing Unit (CPU), a general-purpose processor, a Digital Signal Processor (DSP), an Application Specific Integrated Circuit (ASIC), a Field Programmable Gate Array (FPGA) or other programmable logic devices, transistor logic devices, hardware components or any combination thereof. It can implement or execute various exemplary logic blocks, modules and circuits described in conjunction with the present disclosure. The processor 8001 may also be a combination, such as a combination of one or more microprocessors, a combination of a DSP and a microprocessor, etc., that implements computing functions.

The bus 8002 may include a path for conveying information between the above components. The bus 8002 may be a Peripheral Component Interconnect (PCI) bus or an Extended Industry Standard Architecture (EISA) bus. The bus 8002 may be divided into an address bus, a data bus, a control bus, etc. For ease of representation, FIG. 8 shows the bus 802 through only one thick line, but it does not indicate that there is only one bus or one type of bus.

The memory 8003 may be a Read Only Memory (ROM) or other types of static storage devices that can store static information and instructions, a Random Access Memory (RAM) or other types of dynamic storage devices that can store information and instructions, or an Electrically Erasable Programmable Read Only Memory (EEPROM), a Compact Disc Read Only Memory (CD-ROM) or other optical disk storage, optical disc storage (including compact optical disc, laser disc, optical disc, digital versatile optical disc, Blu-ray disc, etc.), a magnetic disk storage medium or other magnetic storage device, or any other medium that can be used to carry or store desired program code in the form of instructions or data structures and can be accessed by a computer, but is not limited thereto.

The memory 8003 is used to store application code for executing the solutions of the present disclosure, and the execution is controlled by the processor 8001. The processor 8001 is used to execute the application code stored in the memory 8003 to implement those shown in the above method embodiments.

The electronic device includes, but is not limited to, mobile terminals such mobile phones, laptop computers, digital broadcast receivers, personal digital assistants (PDAs), tablet computers (PADs), portable multimedia players (PMPs), vehicle-mounted terminals (such as vehicle-mounted navigation terminals), etc., and fixed terminals such as digital TVs, desktop computers, etc. The electronic device shown in FIG. 8 is only an example and should not bring any limitation on the functions and scope of use of the embodiments of the present disclosure.

The server provided by the present disclosure may be an independent physical server, or a server cluster or distributed system composed of multiple physical servers, or may be a cloud server that provides basic cloud computing services such as cloud services, cloud databases, cloud computing, cloud functions, cloud storage, network services, cloud communications, middleware services, domain name services, security services, CDN, and big data and artificial intelligence platforms. The terminal may be a smart phone, tablet computer, laptop computer, desktop computer, smart speaker, smart watch, etc., but is not limited thereto. The terminal and the server may be directly or indirectly connected via wired or wireless communication, which is not limited in the present disclosure.

An embodiment of the present disclosure provides a computer-readable storage medium having stored there a computer program which, when being run on a computer, causes the computer to perform the corresponding contents in the aforementioned method embodiments.

It should be understood that, although the steps in the flowcharts of the accompanying drawings are shown in sequence as indicated by the arrows, these steps are not necessarily performed sequentially in the order as indicated by the arrows. There is no strict restriction on the performing order of these steps, and they can be performed in other orders, unless otherwise stated herein. Moreover, at least a part of the steps in the flowcharts of the accompanying drawings may include multiple sub-steps or multiple stages, and these sub-steps or stages are not necessarily completed at the same time, but can be performed at different times, and the performing order thereof is not necessarily sequential, but can be performed in turn or alternately with other steps or at least a part of the sub-steps or stages of other steps.

It should be noted that the computer-readable medium mentioned above in the present disclosure may be a computer-readable signal medium or a computer-readable storage medium or any combination of the two. The computer-readable storage medium may be, for example, but is not limited to, an electrical, magnetic, optical, electromagnetic, infrared, or semiconductor system, apparatus or device, or any combination of the above. More specific examples of the computer-readable storage medium may include, but is not limited to, an electrical connection with one or more wires, a portable computer magnetic disk, a hard disk, a random access memory (RAM), a read-only memory (ROM), an erasable programmable read-only memory (EPROM or flash memory), an optical fiber, a portable compact disk read-only memory (CD-ROM), an optical storage device, a magnetic storage device, or any suitable combination of the above. In the present disclosure, the computer-readable storage medium may be any tangible medium containing or storing a program that can be used by or in combination with an instruction execution system, apparatus or device. In the present disclosure, the computer-readable signal medium may include a data signal propagated in a baseband or as part of a carrier wave, which carries computer-readable program code. The propagated data signal may take a variety of forms, including but not limited to electromagnetic signals, optical signals, or any suitable combination of the above. The computer readable signal medium may also be any computer readable medium other than the computer readable storage medium, which may send, propagate or transmit a program for use by or in conjunction with an instruction execution system, apparatus or device. The program code contained on the computer readable medium may be transmitted using any appropriate medium, including but not limited to: wires, optical cables, RF (radio frequency), etc., or any suitable combination of the above.

The computer-readable medium may be included in the electronic device, or may exist independently without being provided in the electronic device.

The computer-readable medium carries one or more programs which, when being executed by the electronic device, cause the electronic device to perform the methods shown in the above embodiments.

According to an aspect of the present disclosure, a computer program product or a computer program is provided, the computer program product or the computer program includes computer instructions, and the computer instructions are stored in a computer-readable storage medium. A processor of a computer device reads the computer instructions from the computer-readable storage medium, and the processor executes the computer instructions, to cause the computer device to perform the methods provided in the above various implementations.

The computer program code for performing the operations of the present disclosure may be written in one or more programming languages, or a combination thereof, including object-oriented programming languages, such as Java, Smalltalk, C++, and conventional procedural programming languages, such as “C” language or similar programming languages. The program code may be executed entirely on the user's computer, partially executed on the user's computer, executed as a separate software package, executed partially on the user's computer and partially on a remote computer, or executed entirely on a remote computer or server. In the cases involving a remote computer, the remote computer may be connected to the user's computer through any type of network, including a local area network (LAN) or a wide area network (WAN), or may be connected to an external computer (e.g., via Internet using an Internet service provider).

The flow charts and block diagrams in the accompanying drawings illustrate the possible architectures, functions and operations of the system, method and computer program product according to various embodiments of the present disclosure. In this regard, each of the blocks in the flow charts or block diagrams may represent a module, a program segment or part of code, and the module, the program segment or the part of code contains one or more executable instructions for realizing the specified logical functions. It should also be noted that in some alternative implementations, the functions marked in the blocks may also occur in a sequence different from that marked in the accompanying drawings. For example, two blocks shown in succession may actually be executed substantially in parallel, or they may sometimes be executed in the opposite order, depending on the functions involved. It should also be noted that each block in the block diagrams and/or flow charts, and the combination of the blocks in the block diagrams and/or flow charts can be implemented with a dedicated hardware-based system that performs a specified function or operation, or can be implemented with a combination of dedicated hardware and computer instructions.

The modules involved in the embodiments described in the present disclosure may be implemented in software or in hardware. The names of the modules do not make limitation on the modules themselves in some cases. For example, A module may also be described as “A module for performing operation B”.

Those described above are only explanations of preferred embodiments of the present disclosure and the technical principles employed. Those skilled in the art should understand that the scope of disclosure involved in the present disclosure is not limited to the technical solutions formed by the above specific combination of the technical features, but should also cover other technical solutions formed by any combination of the above technical features or their equivalent features without departing from the above disclosed concept, for example, a technical solution formed by replacing the above features with the technical features with similar functions disclosed in the present disclosure (but not limited to).

1. A communication method, applied to a sensing initiator, the method comprising:
determining a wireless frame, wherein the wireless frame comprises first indication, and the first indication indicates a wireless local area network (WLAN) sensing measurement process corresponding to the wireless frame; and
sending the wireless frame to a sensing responder to indicate the sensing responder to receive a null data packet (NDP).

2. The communication method according to claim 1, wherein the first indication comprises at least one of a sensing measurement setup identifier included in the WLAN sensing measurement process, or a sensing measurement instance identifier corresponding to the sensing measurement setup identifier.

3. The communication method according to claim 1, wherein the wireless frame comprises a sounding dialog token field, and
the first indication is carried in the sounding dialog token field.

4. The communication method according to claim 1, wherein the wireless frame comprises a station information (STA info) field, and
the STA info field comprises an association identifier (AID) identification field or a user identifier (USID) identification field, and the AID identification field or the USID identification field indicates a responder participating in the WLAN sensing measurement process.

5. The communication method according to claim 4, wherein the STA info field further comprises sensing measurement parameter information corresponding to the AID identification field or the USID identification field.

6. The communication method according to claim 4, wherein the STA info field further comprises parameter information corresponding to transmission of a NDP by the responder.

7. The communication method according to claim 1, wherein the wireless frame further comprises second indication, and the second indication indicates that a type of the wireless frame is a wireless local area network sensing null data packet advertisement (WLAN Sensing NDPA) frame.

8. The communication method according to claim 7, wherein the second indication is carried in a control field of the wireless frame, a subtype subfield of the control field, or a sounding dialog token field.

9. A communication method, applied to a sensing responder, the method comprising:
receiving a wireless frame, and obtain first indication carried in the wireless frame, wherein the first indication indicates a wireless local area network (WLAN) sensing measurement process corresponding to the wireless frame; and
receiving a null data packet (NDP) according to the first indication.

10. The communication method according to claim 9, wherein the first indication comprises at least one of a sensing measurement setup identifier included in the WLAN sensing measurement process, or a sensing measurement instance identifier corresponding to the sensing measurement setup identifier.

11. The communication method according to claim 9, wherein the wireless frame comprises a sounding dialog token field, and
the first indication is carried in the sounding dialog token field.

12. The communication method according to claim 9, wherein the wireless frame comprises a station information (STA info) field, and
the STA info field comprises an association identifier (AID) identification field or a user identifier (USID) identification field, and the AID identification field or the USID identification field indicates a responder participating in the WLAN sensing measurement process.

13. The communication method according to claim 12, wherein the STA info field further comprises sensing measurement parameter information corresponding to the AID identification field or the USID identification field.

14. The communication method according to claim 12, wherein the STA info field further comprises parameter information corresponding to transmission of a NDP by the responder.

15. The communication method according to claim 9, wherein the wireless frame further comprises second indication, and the second indication indicates that a type of the wireless frame is a wireless local area network sensing null data packet advertisement (WLAN Sensing NDPA) frame.

16. The communication method according to claim 15, wherein the second indication is carried in a control field of the wireless frame, a subtype subfield of the control field, or a sounding dialog token field.

17. A network device, the network device being a sensing initiator, and the network device comprising:
a processor; and
a memory storing instructions executable by the processor,
wherein the processor is configured to execute the instructions to cause the network device to:
determine a wireless frame, wherein the wireless frame comprises first indication, and the first indication indicates a wireless local area network (WLAN) sensing measurement process corresponding to the wireless frame; and
send the wireless frame to a sensing responder to indicate the sensing responder to receive a null data packet (NDP).

18. A network device, the network device being a sensing responder, and the network device comprising:
a processor; and
a memory storing instructions executable by the processor,
wherein the processor is configured to execute the instructions to cause the network device to perform the method according to claim 9.

19-22. (canceled)
